(19) United States
(12) Patent Application Publication
(10) Pub. No.: US 2025/0392826 A1
(43) Pub. Date: Dec. 25, 2025

(54) IMAGING CONTROL DEVICE, IMAGING CONTROL METHOD, AND STORAGE MEDIUM

(71) Applicant: CANON KABUSHIKI KAISHA, Tokyo (JP)

(72) Inventor: SHUNSUKE KAWAHARA, Saitama (JP)

(21) Appl. No.: 19/239,564

(22) Filed: Jun. 16, 2025

(30) Foreign Application Priority Data
Jun. 19, 2024 (JP) 2024-098645

(51) Int. Cl. H04N 23/73; H04N 23/76

(52) U.S. Cl. CPC H04N 23/73; H04N 23/76

(57) ABSTRACT

An imaging control device includes at least one memory storing instructions, and at least one processor that, upon execution of the stored instructions, causes the imaging device to function an acquisition unit configured to acquire an image, a calculation unit configured to calculate a parameter related to atmospheric transmittance from the image, a determination unit configured to determine, based on the parameter calculated by the calculation unit, a program diagram to be used for controlling exposure of an imaging unit from among a plurality of program diagrams, and a control unit configured to control the imaging unit to perform imaging using the program diagram determined by the determination unit.

### BACKGROUND

### Field of the Disclosure

The present disclosure relates to an imaging control device, an imaging control method, and a storage medium.

### Description of the Related Art

Conventionally, surveillance cameras have been used as one of crime prevention measures. Surveillance cameras are installed in various environments, and desirably provide images with high visibility. However, if a fog or haze occurs in the image capturing environment of the surveillance camera, the contrast of the subject decreases, resulting in an image with poor visibility. In order to obtain images with high visibility even in the image capturing environment with occurrence of a fog or haze, there is known a technique by which to perform contrast enhancement in the event of a fog or haze.

There is known another technique for obtaining images with high visibility by which to estimate light scattering in the atmosphere and remove the light scattering. There are two types of light scattering in the atmosphere. One is Mie scattering, which is light scattering caused by particles with a diameter larger than the wavelength of light, such as dust, dirt, and water vapor particles. Since Mie scattering occurs regardless of the wavelength of light, the more distant subject appears whiter due to decrease in contrast at the occurrence of Mie scattering. The other is Rayleigh scattering in which light with a shorter wavelength is more scattered by air molecules or the like so that the scattered light that reaches the eyes has more blue components, and the more distant subject appears bluer overall. As a technique for correcting an image with reduced visibility due to light scattering, there is a technique by which to improve contrast using an image (dark channel image) in which the minimum pixel values in all RGB channels in a specified range around each pixel of interest are extracted. The technique for improving the visibility using a dark channel image is called the dark channel prior (DCP) method.

However, an image that has undergone fog/haze removal using the DCP method generally has a reduced image luminance. For example, in the case of performing fog/haze removal using the DCP method on an image that has been properly exposed in a camera, the image luminance is reduced, making it difficult to obtain a proper exposure. In view of this, Japanese Unexamined Patent Application Publication No. 2014-527244 discusses a technique for obtaining a proper exposure by enhancing the exposure of an image that has undergone fog/haze removal by the DCP method, using an exposure enhancement function to restore the image luminance.

### SUMMARY

An issue to be solved by the present disclosure is to obtain appropriate exposure while suppressing an increase in noise when performing fog/haze removal using the dark channel prior (DCP) method.

According to an aspect of the present disclosure, an imaging control device includes at least one memory storing instructions, and at least one processor that, upon execution of the stored instructions, causes the imaging device to function an acquisition unit configured to acquire an image, a calculation unit configured to calculate a parameter related to atmospheric transmittance from the image, a determination unit configured to determine, based on the parameter calculated by the calculation unit, a program diagram to be used for controlling exposure of an imaging unit from among a plurality of program diagrams, and a control unit configured to control the imaging unit to perform imaging using the program diagram determined by the determination unit.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an image processing device.

FIG. 2 is a flowchart illustrating a process performed by the image processing device.

FIGS. 3A, 3B, and 3C are diagrams illustrating examples of a first program diagram.

FIGS. 4A, 4B, and 4C are diagrams illustrating examples of a second program diagram.

### DESCRIPTION OF THE EMBODIMENTS

Hereinafter, exemplary embodiments for carrying out the present disclosure will be described in detail with reference to the accompanying drawings. The exemplary embodiments described below are examples of means for realizing the present disclosure, and should be modified or changed as appropriate depending on the configuration of the device to which the present disclosure is applied and various conditions, and the present disclosure is not limited to the following exemplary embodiments. In addition, the exemplary embodiments described below may be partially combined as appropriate.

### Device Configuration

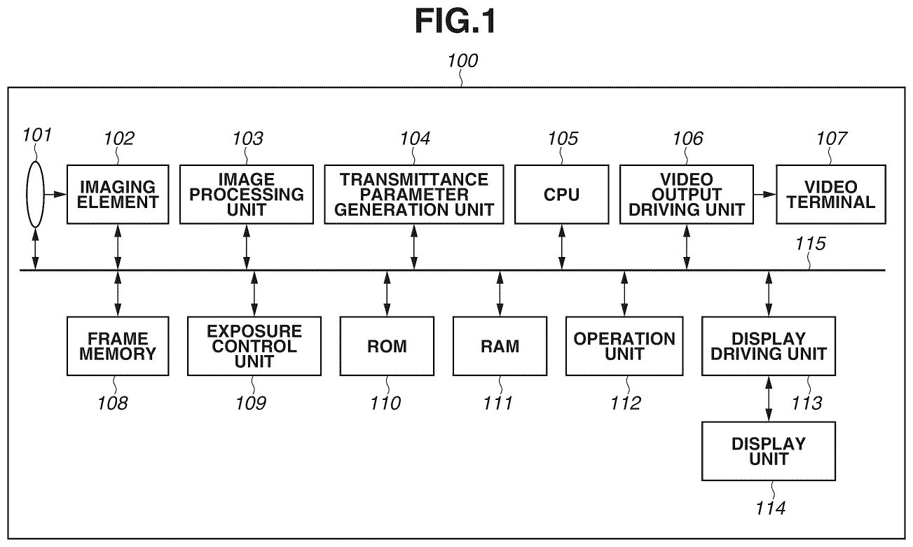

A configuration of an image processing device (imaging control device) according to an exemplary embodiment will be described. FIG. 1 is a diagram illustrating a configuration of the image processing device according to the present exemplary embodiment. The blocks illustrated in FIG. 1 are connected to each other via an internal bus 115, and are capable of exchanging data with each other.

An optical lens 101 (imaging unit) is an optical element that includes a lens and a motor for driving the lens. The optical lens 101 operates based on a control signal and can optically enlarge or reduce an image and adjust the focal length and the like. In addition, in the case of adjusting the amount of incident light, the amount of light can be adjusted to a desired brightness by controlling the aperture area of the diaphragm. The light having transmitted through the lens is imaged by an imaging element 102.

The imaging element 102 (imaging unit) is a charge-coupled device (CCD) sensor, a complementary metal oxide semiconductor (CMOS), or the like, and serves to convert optical signals into electrical signals. The imaging element 102 is driven based on a control signal to reset the charge in the pixels and control the timing of readout.

The imaging element 102 also has the functions of performing gain processing on pixel signals read out as electrical analog signals (voltage values) and converting analog signals into digital signals.

An image processing unit 103 performs various types of image processing on the image output from the imaging element 102. For example, the image processing unit 103 can correct the amount of light in the part around the image generated due to the characteristics of the optical lens 101, correct sensitivity variation among the pixels of the imaging element 102, and perform color correction and flicker correction. The image processing unit 103 also has the function of performing sharpening processing using parameters related to the transmittance generated by a transmittance parameter generation unit 104, the details of which will be described below. The transmittance parameter generation unit 104 generates parameters related to the transmittance of the subject and airglow for sharpening the image using the dark channel prior (DCP) method. The DCP method will be described below in detail.

In automatic exposure control, an exposure control unit 109 detects the brightness of an image, narrows the aperture to an appropriate brightness, and automatically controls the shutter speed and gain. In manual exposure control, the exposure control unit 109 detects the brightness of an image and calculates a value indicating how bright the image in the current state is relative to the appropriate brightness.

A frame memory 108 is generally called a random access memory (RAM), and is an element that temporarily stores video signals, which can be read out when necessary. Since video signals have a huge amount of data, the frame memory 108 needs to operate at high speed and have a large capacity. In recent years, dual data rate 4-synchronous dynamic RAMs (DDR4-SDRAMs) and the like have been often used. The use of the frame memory 108 makes it possible to perform various processes. For example, the frame memory 108 is an essential element for image processing, such as combining images that differ in time and cutting out only the required area of an image.

The image processing device 100 includes a central processing unit (CPU) 105 as a CPU for controlling each function of the image processing device 100. To drive the CPU 105, a read only memory (ROM) and a RAM are connected.

A ROM 110 is a non-volatile element that stores programs for operating the CPU 105, various adjustment parameters, and the like. A program read from the ROM 110 is loaded to a volatile RAM 111 and executed by the CPU 105. The RAM 111 provides a work area for the CPU 105.

The image generated by the image processing unit 103 is output to the outside of the image processing device 100 via a video output driving unit 106 and a video terminal 107. Representative interfaces include serial digital interface (SDI) and high definition multimedia interface (HDMI) (registered trademark). There are also various other interfaces such as DisplayPort (registered trademark), which make it possible to display real-time video images on an external monitor and the like. Further, the image generated by the image processing unit 103 is displayed on a display device.

The display unit 114 is a display device that can be visually recognized by a user, and can display images processed by the image processing unit 103, setting menus, and the like, and allows the user to check the operating status of the image processing device 100, for example. In recent years, a small-sized, low-power device such as a liquid crystal display (LCD) or an organic electroluminescence (EL) display has been used as the display unit 114. Further, the display unit 114 may also serve as a resistive or capacitive thin-film element called a touch panel. The CPU 105 generates character strings for informing the user of the setting state of the image processing device 100 and menus for setting the image processing device 100, and displays them on the display unit 114 in a state of being superimposed on the image processed by the image processing unit 103. In addition to character information, it is also possible to superimpose imaging assist indications such as a histogram, a vector scope, a waveform monitor, a zebra pattern, focus peaking, and a false color.

### Transmittance Calculation Process

Next, a process performed by the transmittance parameter generation unit 104 will be described in detail. First, an image I in which fog or haze is present and an image J after fog/haze removal are related to each other by an atmospheric model as in Equation (1) as follows:

$$I ( x , y ) = J ( x , y ) \cdot t ( x , y ) + A ( 1 - t ( x , y ) ) , \qquad Equation ( 1 )$$

where x and y indicate two-dimensional coordinate positions in the horizontal and vertical directions in the image, t indicates the transmittance map of fog or haze, and A indicates airglow. The transmittance map t(x, y) represents attenuation due to the atmosphere. The farther the subject is from the image processing device 100, the greater the amount of attenuation (pixel value), and the closer the subject is, the smaller the amount of attenuation (pixel value). In Equation (1), estimating the airglow A and the transmittance map t(x, y) makes it possible to determine J(x, y) after fog/haze removal.

First, a method for estimating the ambient light A will be described using an equation. The ambient light A is calculated for each color of RGB. Accordingly, the airglow A(c) for each color is expressed by Equation (2) as follows:

$$A ( c ) = {ave}_{( x , y , c ) ∈ Ωsky} I ( x , y , c ) \qquad Equation ( 2 )$$

where ave function represents a function of calculating the average value in the argument, c represents a color component, and Ωsky indicates a local region in a sky area. The sky area here can be specified by a method by which to calculate the sky area based on the distribution of a histogram, a method by which to use a coordinate position designated in advance, a method by which to use a position specified by a user, or the like, for example. The ambient light A(c) is estimated here using an image I(x, y, c) in which fog or haze is present, but the average value of the local region Ωsky may be calculated using a dark channel value Idrk(c) described below. In addition, the average of the top 10% of dark channel values Idrk(x, y, c) described below may be set as the ambient light A(c) without specifying the sky area. The top 10% is used here, but the present disclosure is not limited to this, and a predetermined number of pixels may be used.

Next, the dark channel Idrk(x, y, c) for each color is expressed by Equation (3) as follows:

$$Idrk ( x , y , c ) = {min}_{( x , y , c ) ∈ Ω} I ( x , y , c ) \qquad Equation ( 3 )$$

where c represents a color component, where C=1 indicates an R image, C=2 indicates a G image, and C=3 indicates a B image, and 2 indicates a local region including the target coordinates (x, y, c). As illustrated in Equation (3), the dark channel value is the minimum value in the local region including the target pixels. Substituting the dark channel calculation in Equation (3) into the atmospheric model in Equation (1) makes it possible to obtain Equation (4) for calculating the dark channel value for each color of RGB from the atmospheric model as follows:

$$Idrk ( c ) = Jdrk ( x , y , c ) \cdot t ( x , y , c ) + A ( 1 - t ( x , y , c ) ) \qquad Equation ( 4 )$$

Assuming that in an image without fog or haze, the pixel values of color components are locally small, the dark channel value Jdrk(x, y, c) of the image after fog/haze removal in Equation (4) is extremely close to 0. Therefore, Equation (4) can be approximated as Equation (5) as follows:

$$Jdrk ( x , y , c ) \approx A ( 1 - t ( x , y , c ) ) \qquad Equation ( 5 )$$

Modifying the approximation expression in Equation (5) makes it possible to estimate the transmittance map t(x, y, c) for each color of RGB as in Equation (6) as follows:

$$t ( x , y , c ) \approx 1 - \{ ω \times \frac{Idrk ( x , y , c )}{A ( c )} \} \qquad Equation ( 6 )$$

In Equation (6), ω is a parameter for controlling the degree of fog/haze correction and is defined in the range of 0.0 to 1.0. The larger the value of the parameter, the higher the effect of fog/haze correction can be set. Substituting the airglow A(c) and transmittance map t(x, y, c) calculated in Equations (2) to (6) described above into Equation (7) makes it possible to determine J(x, y, c) after fog/haze removal as follows:

$$J ( x , y , c ) = \{ \frac{I ( x , y , c ) - A ( c )}{t ( x , y , c )} \} + A ( c ) \qquad Equation ( 7 )$$

Next, Equation (7) is calculated using the airglow estimation value A(c) and the transmittance map t(x, y, c) calculated for each color. This makes it possible to generate an image non(x, y) (hereinafter, referred to as a non-scattering image) from which the component corresponding to Mie scattering (hereinafter, referred to as the Mie scattering component) and the component corresponding to Rayleigh scattering (hereinafter, referred to as the Rayleigh scattering component) are removed. Also, calculating Equation (7) using the airglow estimate value A(c) and the minimum value of the transmittance map t(x, y, c) calculated for each color makes it possible to generate an image from which the Mie scattering component is removed (hereinafter, referred to as Mie scattering-removed image). Further, subtracting the image from which the Mie scattering component has been removed from the original image acquired from the imaging element 102 makes it possible to extract a Mie scattering component mie(x, y, c). Moreover, subtracting the non-scattering image and the Mie scattering component from the original image acquired from the imaging element 102 makes it possible to extract a Rayleigh scattering component ray(x, y, c). Dividing the extracted Mie scattering component and Rayleigh scattering component by the original image acquired from the imaging element 102 makes it possible to calculate the relative values of the Mie scattering component and Rayleigh scattering component as follows:

J(x, y, c)=non(x, y, c)+Wray·ray(x, y, c)+Wmie·mie(x, y, c) Equation (8),

where Wray is a correction coefficient parameter for the Rayleigh scattering component, and Wmie is a correction coefficient parameter for the Mie scattering component. Both correction coefficient parameters are defined in the range of 0.0 to 1.0. As the value of the correction coefficient parameter is smaller, the correction amount of the scattering component after fog/haze removal is smaller, and the effect of fog/haze correction can be set to be higher. In addition, separately correcting the Rayleigh scattering component and the Mie scattering component makes it possible to determine J(x, y, c) after fog/haze removal, while suppressing adverse effects on colors and the like caused by fog/haze removal.

### Description of Operations

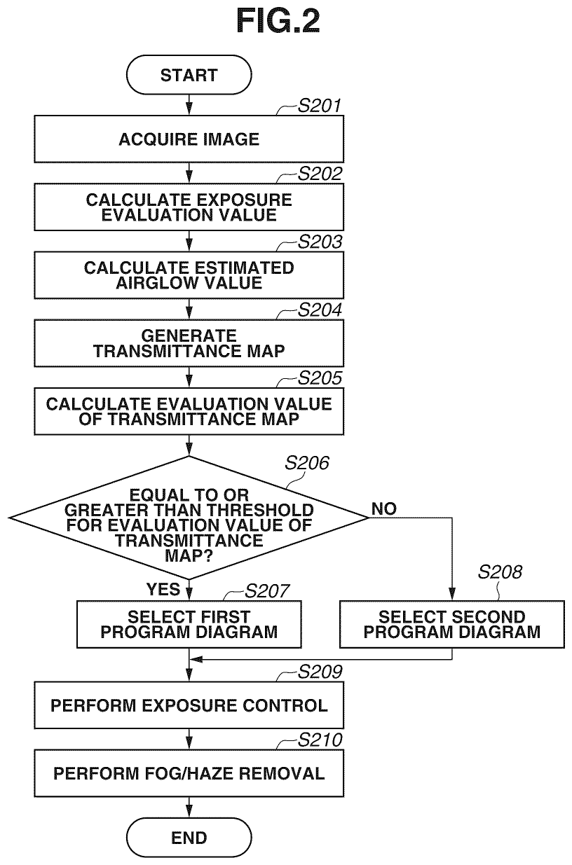

The process of fog/haze removal and exposure control performed by the image processing device 100 according to the results of the transmittance map will be described with reference to FIGS. 2 to 4C. The process in the flowchart of FIG. 2 is started after the image processing device 100 is started. Alternatively, an item for setting whether to perform fog/haze removal and an item for setting a mode related to exposure control are provided in a menu or a camera on screen display (OSD). Then, the process is started when the user sets execution of fog/haze removal and automatic exposure control via an operation unit 112. The process in the flowchart is repeatedly executed when the execution of fog/haze removal and the mode for automatically performing exposure control are set in combination. If this combination is not set, steps S205 to S208 are not executed. The execution and non-execution of steps S205 to S208 of the process in the flowchart may be changed depending on whether to prioritize the exposure of the image having undergone fog/haze removal. For example, when the video terminal 107 outputs two types of images to be and not to be subjected to fog/haze removal, steps S205 to S208 in the process of the flowchart are executed only when the image to be subjected to fog/haze removal is the main video image output. Each step illustrated in the flowchart is implemented by loading a program from the ROM 110 into the RAM 111 and executing the same by the CPU 105.

In step S201, the CPU 105 (acquisition unit) acquires an image from the imaging element 102.

In step S202, the exposure control unit 109 (evaluation unit) calculates an exposure evaluation value from the image acquired in step S201. For example, an item for setting a photometry method is provided in a menu, and the luminance values of the pixels are multiplied by coefficients according to the pixel positions of the image according to the selected photometry method, and the average of the luminance values is calculated as the exposure evaluation value. Alternatively, the exposure evaluation value may be calculated solely from pixels in a predetermined area of the image.

In step S203, the transmittance parameter generation unit 104 calculates an estimated airglow value for each color from the image acquired in step S201 using the DCP method.

Next, in step S204, the transmittance parameter generation unit 104 generates a transmittance map for each color using the DCP method from the image acquired in step S201 and the estimated airglow value calculated in step S203.

Next, in step S205, the CPU 105 (calculation unit) calculates a transmittance map evaluation value from the transmittance map generated in step S204. The transmittance map evaluation value here is an index that indicates the transmittance state of fog or haze in the image. Specifically, the average value of all pixels in the transmittance map is set as the transmittance map evaluation value. The transmittance map evaluation value may be obtained by calculating the average value for the R, G, and B channels of the transmittance map. The transmittance map evaluation value may be obtained by multiplying the transmittance map values of the individual pixels by coefficients according to the pixel positions of the image according to the photometry method and averaging the resultant values. The transmittance map evaluation value may be calculated solely from the pixels in the same area as the area used to calculate the exposure evaluation value. The transmittance map evaluation value may be obtained by averaging a plurality of calculation results including past calculation results.

Next, in step S206, the CPU 105 determines whether the transmittance map evaluation value calculated in step S205 is equal to or greater than a predetermined threshold. As the transmittance map evaluation value is larger, the effect of correction by fog/haze removal becomes higher. Therefore, if the transmittance map evaluation value is equal to or greater than the predetermined threshold (YES in step S206), the CPU 105 determines that the effect of correction by fog/haze removal is low, and the process proceeds to step S207. If the transmittance map evaluation value is less than the threshold (NO in step S206), the CPU 105 determines that the effect of correction by fog/haze removal is high, and the process proceeds to step S208. If the transmittance map evaluation value is calculated for each of the R, G, and B channels in step S205, the CPU 105 may determine whether the transmittance map evaluation value only for a specific channel is equal to or greater than the predetermined threshold, such as the transmittance map evaluation value only for the G channel, for example. The CPU 105 may determine whether the transmittance map evaluation value for any one of the R, G, and B channels is equal to or greater than the predetermined threshold, and determine the amount of correction by fog/haze removal according to the result of the determination on the transmittance map evaluation value. Instead of using the transmittance map evaluation value, an item for setting the intensity of fog/haze removal may be provided in a menu or camera OSD, and the determination may be made based on the setting for the intensity of fog/haze removal. In this case, if the intensity of fog/haze removal is high, the process proceeds to step S208, and if the intensity of the fog/haze removal is low, the process proceeds to step S207. For example, the setting for the intensity of fog/haze removal is a setting for adjusting ω, which is a correction intensity parameter of fog/haze removal in Equation (6), and adjusting Wray and Wmie, which are correction coefficient parameters of the scattering components in Equation (8). Step S206 may be performed at a slower cycle than that in the flowchart, such as once every 60 times, for example, to prevent repeated changes in the program diagram at the time the subject changes and reduce the influence on the video image. In the present exemplary embodiment, the selection of two program diagrams for a predetermined threshold has been taken as an example. Alternatively, two or more predetermined thresholds may be provided and three or more program diagrams may be selected.

In step S207, the CPU 105 loads a first program diagram from the ROM 110 into the RAM 111. The first program diagram here is a program diagram used when the effect of correction by fog/haze removal is determined as low in step S206.

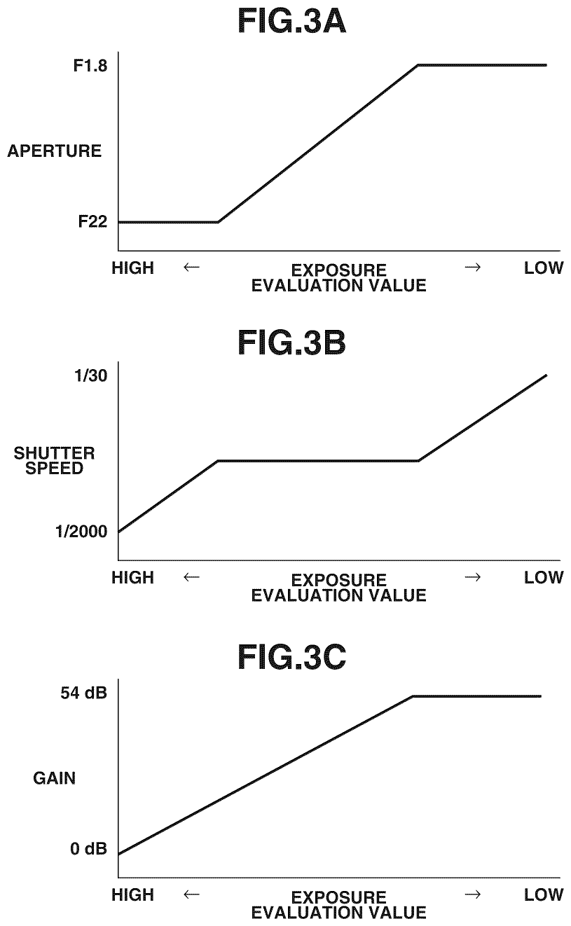

For example, the first program diagram includes data on the setting values of the aperture, shutter speed, and gain corresponding to the exposure evaluation value as illustrated in FIG. 3.

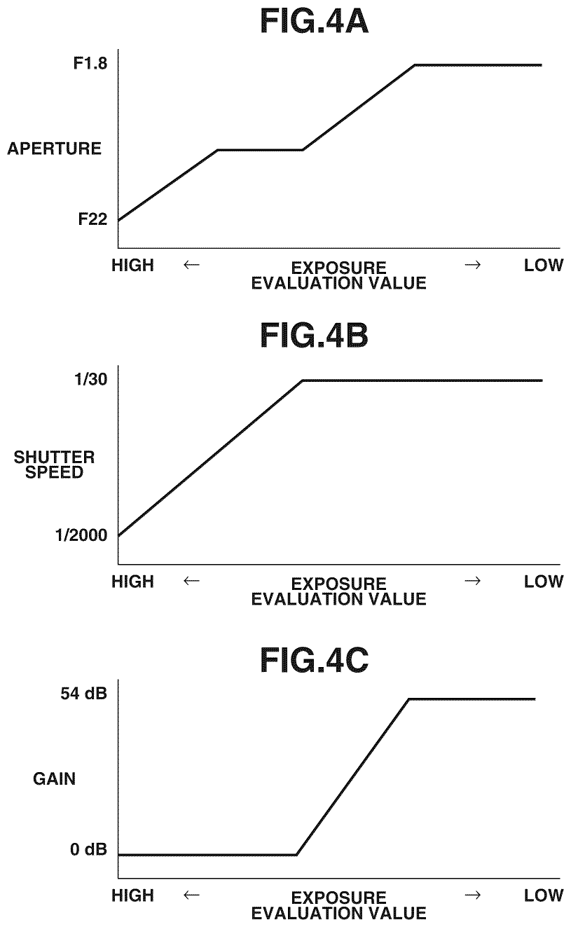

Next, in step S208, the CPU 105 loads a second program diagram from the ROM 110 into the RAM 111. The second program diagram here is a program diagram used when the correction effect of the fog/haze removal is determined as high in step S206. For example, the second program diagram includes data on the setting values of the aperture, shutter speed, and gain corresponding to the exposure evaluation value as illustrated in FIG. 4. The second program diagram here is characterized in that, with the same exposure evaluation value, the shutter speed is set to a long time, the diaphragm is opened, and the gain is set to a low value compared to those in the first program diagram. Similarly, in the case of selecting three or more program diagrams, as the transmittance map evaluation value is lower, a program diagram with a lower gain is selected. Therefore, as the effect of correction by fog/haze removal is higher, a program diagram with a lower gain is selected. This suppresses an increase in noise on the premise that an appropriate exposure can be obtained. The exposure control setting is not limited to automatic exposure control, and a program diagram having similar characteristics may be used in the Av mode in which exposure control is performed with priority given to the aperture or the Tv mode in which exposure control is performed with priority given to the shutter speed. If the gain setting is made by a combination of an analog gain and a digital gain of the sensor, the second program diagram may be characterized in that the digital gain is set to a lower value compared to that in the first program diagram.

Through steps S206 to S208, an appropriate program diagram is selected from among the plurality of program diagrams based on the parameters related to the atmospheric transmittance calculated in step S205.

In step S209, the exposure control unit 109 (control unit) performs exposure control using the program diagram loaded in the RAM 111 in step S207 or S208. Specifically, the exposure control unit 109 controls the aperture, shutter speed, and gain based on the exposure evaluation value calculated in step S202 and the program diagram such that the image has appropriate brightness. In other words, the exposure control unit 109 controls the optical lens 101 and the imaging element 102, which are the imaging unit, to capture an image using the determined program diagram.

In step S210, the image processing unit 103 performs fog/haze removal on the image acquired in step S201, using the estimated airglow value calculated in step S203 and the transmittance map generated in step S204.

In the present exemplary embodiment, as an example, the exposure control processing in step S209 was followed by the fog/haze removal processing in step S210. Alternatively, the exposure control processing may be performed after the fog/haze removal processing.

According to the technique discussed in Japanese Unexamined Patent Application Publication No. 2014-527244, it is possible to restore the luminance of an image that has been reduced by fog/haze removal using the DCP method, by using an exposure enhancement function. However, since the luminance correction is performed using the exposure enhancement function, the noise in the image also increases resulting in degradation in the image quality. Further, even in the case of performing fog/haze removal on an image that has been exposure-corrected taking into account the reduction in luminance due to fog/haze removal, the noise is likely to be noticeable due to fog/haze removal.

On the other hand, according to the imaging control device of the present exemplary embodiment, when the effect of correction by fog/haze removal is higher, a program diagram with a lower gain is selected using the transmittance map, which makes it possible to obtain appropriate exposure while suppressing the increase in noise that would occur when fog/haze removal is performed.

For example, a modification of the present exemplary embodiment may be a system in which an imaging device and an imaging control device are separate devices that communicable with each other. In this case, an imaging device incorporating an optical lens 101 and an imaging element 102 is used as an imaging unit, and the imaging control device acquires an image captured by the imaging device and executes the operations in the flowchart in FIG. 2. Then, in step S209, an instruction is given via a network to the imaging device to execute exposure control according to the program diagram determined by a determination unit. At this time, a storage medium that stores a plurality of program diagrams may be in either the imaging device or the imaging control device. In the case of incorporating the storage medium in the imaging control device, the shutter speed, aperture, and gain are determined by the imaging control device based on the determined program diagram and the image acquired from the imaging device.

The determined imaging parameters are then output to the imaging device via the network. In the case of incorporating a storage medium storing a plurality of program diagrams into the imaging device, the program diagrams are stored in association with index values for reference to the program diagrams. In step S209, the imaging control device outputs an index value corresponding to the determined program diagram, to the imaging device via the network. This makes it possible to instruct the imaging device which program diagram to use.

The present disclosure also includes cases where a software program for implementing the functions of the above-described exemplary embodiments is supplied to a system or apparatus having a computer capable of executing the program, directly from a recording medium or via wired/wireless communication, and the program is executed.

Therefore, the program code itself that is supplied to and installed on a computer to perform the functional processing of the present disclosure also embodies the present disclosure. That is, the computer program itself for performing the functional processing of the present disclosure is also included in the present disclosure.

In this case, as long as the program has program functions, the program may be provided in any form, such as an object code, a program executed by an interpreter, or script data supplied to an operating system (OS).

The recording medium for supplying the program may be a hard disk, a magnetic recording medium such as a magnetic tape, an optical/magneto-optical storage medium, or a non-volatile semiconductor memory, for example.

As a method of supplying the program, a method is also conceivable by which a computer program constituting the present disclosure is stored in a server on a computer network, and a connected client computer downloads the computer program to execute the program.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-098645, filed Jun. 19, 2024, which is hereby incorporated by reference herein in its entirety.

What is claimed is:

1. An imaging control device comprising:
at least one memory storing instructions; and
at least one processor that, upon execution of the stored instructions, causes the imaging control device to function as:
an acquisition unit configured to acquire an image;
a calculation unit configured to calculate a parameter related to atmospheric transmittance from the image;
a determination unit configured to determine, based on the parameter calculated by the calculation unit, a program diagram to be used for controlling exposure of an imaging unit from among a plurality of program diagrams; and
a control unit configured to control the imaging unit to perform imaging using the program diagram determined by the determination unit.

2. The imaging control device according to claim 1, wherein the parameter related to the atmospheric transmittance is an average value of a transmittance map.

3. The imaging control device according to claim 2, wherein the determination unit determines a program diagram with a lower gain setting as the average value of the transmittance map is lower.

4. The imaging control device according to claim 2,
wherein the plurality of program diagrams includes a first program diagram and a second program diagram,
in a case where the average value of the transmittance map is equal to or greater than a predetermined threshold, the first program diagram is determined as the program diagram to be used for controlling the exposure of the imaging unit, and, in a case where the average value of the transmittance map is not equal to or greater than the predetermined threshold, the second program diagram is determined as the program diagram to be used for controlling the exposure of the imaging unit.

5. The imaging control device according to claim 4, wherein, with the same exposure evaluation value, a gain setting value in the second program diagram is smaller than a gain setting value in the first program diagram.

6. The imaging control device according to claim 4, wherein, with the same exposure evaluation value, a shutter speed setting value in the second program diagram is a longer-time setting value than a shutter speed setting value in the first program diagram.

7. The imaging control device according to claim 4, wherein, with the same exposure evaluation value, an aperture setting value in the second program diagram is smaller than an aperture setting value in the first program diagram.

8. The imaging control device according to claim 1, further comprising:
an evaluation unit configured to calculate an exposure evaluation value from the acquired image; and
a control unit configured to control exposure based on the exposure evaluation value and the program diagram determined by the determination unit.

9. The imaging control device according to claim 1, wherein the parameter related to the atmospheric transmittance has a value calculated based on a transmittance map and a coefficient according to a pixel position at a time of calculation of an exposure evaluation value.

10. The imaging control device according to claim 1, wherein the parameter related to the atmospheric transmittance has an evaluation value calculated based on a transmittance map and an area used for calculating an exposure evaluation value.

11. The imaging control device according to claim 1, wherein the determination unit determines the program diagram to be used for controlling the exposure of the imaging unit based on a parameter related to intensity of fog/haze removal.

12. The imaging control device according to claim 8, wherein the determination of the program diagram by the determination unit is executed at a slower cycle than the exposure control by the control unit.

13. The imaging control device according to claim 1, further comprising a storage unit configured to store the plurality of program diagrams.

14. The imaging control device according to claim 1, wherein the plurality of program diagrams has different setting values for at least one of aperture, shutter speed, and gain.

15. An imaging control method comprising:
acquiring an image;
calculating a parameter related to atmospheric transmittance from the image;
determining, based on the parameter calculated by the calculating, a program diagram to be used for controlling exposure of an imaging unit from among a plurality of program diagrams; and
controlling the imaging unit to perform imaging using the program diagram determined by the determining.

16. A non-transitory computer-readable medium storing computer-executable instructions for causing a computer execute an imaging control method comprising:
acquiring an image;
calculating a parameter related to atmospheric transmittance from the image;
determining, based on the parameter calculated by the calculating, a program diagram to be used for controlling exposure of an imaging unit from among a plurality of program diagrams; and
controlling the imaging unit to perform imaging using the program diagram determined by the determining.
